(19) United States
(12) Patent Application Publication
(10) Pub. No.: US 2024/0181279 A1
(43) Pub. Date: Jun. 6, 2024

(54) MULTI-ANGLE BEARING HEAD

(71) Applicant: 9105-0732 Québec Inc., Granby (CA)

(72) Inventors: Martin DUFOUR, Shefford (CA); Michael PARKER, Ste-Julie (CA)

(21) Appl. No.: 18/521,075

(22) Filed: Nov. 28, 2023

Related U.S. Application Data
(60) Provisional application No. 63/429,682, filed on Dec. 2, 2022.

(51) Int. Cl. A62B 1/18; A62B 1/06; A62B 35/00

(52) U.S. Cl. CPC A62B 1/18; A62B 1/06; A62B 35/0093

(57) ABSTRACT

A hoisting apparatus or PPE for use at a manhole comprises a structure mountable to a surface, the manhole and/or a structure present in the vicinity of the manhole. The hoisting apparatus comprises a multi-angle bearing assembly mounted at one end of the structure that is adapted to have a rope or alike attached or anchored to a point of the structure distant to the multi-head bearing assembly to guide the rope when the rope extends in one of an available range of directions. The multi-angle bearing assembly comprises a ring assembly defining an opening adapted for the rope to go through, and a plurality of spools mounted to the ring assembly adapted to guide the rope in a path distant from the edge of the ring assembly in any if the direction of the rope of the range of available directions.

### CROSS-REFERENCE TO RELATED APPLICATION

This application relates to and is a non-provisional application claiming priority under 35 U.S.C. § 119(e) from U.S. patent application No. 63/429,682, filed Dec. 2, 2022, under 35 U.S.C. § 111, entitled MULTI-ANGLE BEARING HEAD, the specification of which is hereby incorporated herein by reference in its entirety.

### BACKGROUND

### (a) Field

The subject matter disclosed generally relates to the field of hoisting apparatuses and rescue assemblies. More particularly, it concerns improvements in components of a hoisting apparatus for use e.g., at a manhole or any confined space entry for fall protection, rescue purposes or simply for lowering and raising a person or an object entering the manhole or alike.

### (b) Related Prior Art

Manholes provide access to confined spaces or underground structures such as a sewer, boiler, drain or other similar structures. Often, people have to go into such confined spaces, with or without working material. They usually go into and come out of the manhole by means of a long ladder and a protective fence is usually erected around the opening of the manhole in order to prevent people that may pass thereby from falling into the manhole.

People working in manholes occasionally get seriously injured and, as a result thereof, require to be evacuated as quickly and as safely as possible from the manhole in order to be attended by a professional, such as a doctor and the like.

In such condition, it is important to continuously improve safety equipment, including hoisting apparatuses, for operation around manholes.

Thus, there is still a need for improvement in this field, including improvement in hoisting apparatuses and components thereof.

### SUMMARY

According to an aspect, there is provided a hoisting apparatus for use at a manhole comprises a structure mountable to a surface, the manhole and/or a structure present in the vicinity of the manhole. The hoisting apparatus comprises a multi-angle bearing assembly mounted at one end of the structure that is adapted to have a rope or alike attached or anchored to a point of the structure distant to the multi-head bearing assembly to guide the rope when the rope extends in one of an available range of directions. The multi-angle bearing assembly comprises a ring assembly defining an opening adapted for the rope to go through, and a plurality of spools mounted to the ring assembly adapted to guide the rope in a path distant from the edge of the ring assembly in any if the direction of the rope of the range of available directions.

In some aspects, the techniques described herein relate to a multi-angle bearing head, including: a ring defining a central passage therethrough; and at least one bearing member coupled to the ring, the at least one bearing member extending at least partially within the central passage thereby providing a guide for a rope to pass through the ring by the central passage without the rope robbing against the ring.

In some aspects, the techniques described herein relate to a multi-angle bearing head, wherein the ring includes an inner edge and an outer edge, and a hole distant from the inner edge and the outer edge.

In some aspects, the techniques described herein relate to a multi-angle bearing head, including a support secured to the ring.

In some aspects, the techniques described herein relate to a multi-angle bearing head, wherein the support includes a support component secured to the ring, a base securable to a structure, wherein the support component and the base are rotatable relative to each other.

In some aspects, the techniques described herein relate to a multi-angle bearing head, wherein the support component and the base include holes that can be aligned when the support component is rotated at a first angle and at a second angle relative to the base, and a pin mountable to the holes to releasably secure the multi-angle bearing head at the first angle and at the second angle.

In some aspects, the techniques described herein relate to a multi-angle bearing head, wherein including a disk assembly coupled to the ring, the disk assembly adapted for freely pivoting around a passage axis extending through the central passage.

In some aspects, the techniques described herein relate to a multi-angle bearing head, wherein the bearing member is a spool mounted to the disk assembly.

In some aspects, the techniques described herein relate to a multi-angle bearing head, wherein the disk assembly includes a first disk and a second disk that are coupled to each other with the ring wedged in-between.

In some aspects, the techniques described herein relate to a multi-angle bearing head, wherein the disk assembly includes a low-friction coupling component wedged between the first disk and the ring.

In some aspects, the techniques described herein relate to a multi-angle bearing head, wherein the ring includes a circular inner edge, and wherein the coupling component is adapted for the first disk to slide relative to the inner edge and thereby pivoting around the passage axis.

In some aspects, the techniques described herein relate to a multi-angle bearing head, wherein the bearing member is a spool including a shaft wedged between the first disk and the second disk.

In some aspects, the techniques described herein relate to a multi-angle bearing head, further including fittings mounted to the first disk, and a pilot mounted to the fittings providing a path for the rope between the pilot and the bearing member.

In some aspects, the techniques described herein relate to a multi-angle bearing head, wherein the pilot has a first end and a second end, the guide being rotatable relative to a first one of the fittings, the multi-angle bearing head including a releasable pin adapted to releasably mount the second end to a second one of the fittings.

In some aspects, the techniques described herein relate to a multi-angle bearing head, wherein the disk assembly is able to freely pivot around the passage axis, being thereby able to pivot over more than 360 degrees.

In some aspects, the techniques described herein relate to a multi-angle bearing head, wherein the spool has two edges having an edge diameter, and an intermediary diameter in-between that is smaller than the edge diameter.

In some aspects, the techniques described herein relate to a multi-angle bearing head, wherein the ring consists in a first jaw and a second jaw rotatable relative to the first jaw between an open position and a closed position.

In some aspects, the techniques described herein relate to a multi-angle bearing head, wherein the bearing member consists of a plurality of spools neighboring each other and providing together a guiding surface with gaps smaller than a diameter of the rope to be used.

In some aspects, the techniques described herein relate to a multi-angle bearing head, wherein the neighboring spools have pivot axes that are oblique to each other.

In some aspects, the techniques described herein relate to a multi-angle bearing head, wherein the guiding surface defines a closed perimeter in the closed position.

In some aspects, the techniques described herein relate to an apparatus used as a hoisting apparatus or a personal protective apparatus for use at a manhole, the apparatus including: a structure; and a multi-angle bearing head, the multi-angle bearing head being coupled to the structure, wherein the multi-angle bearing head defines a passage having a substantially closed perimeter adapted for a rope to pass therethrough.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective view of a hoisting apparatus comprising a multi-angle bearing head in accordance with a first embodiment;

FIG. 2 is an elevation view of a portion of a spine of a hoisting apparatus with a multi-angle bearing head of FIG. 1 mounted thereto in a raised position;

FIG. 3. is an elevation view of the portion of the spine and the multi-angle bearing head of FIG. 2 with the multi-angle bearing head in a sloped position;

FIG. 4 is a front view of a mounted multi-angle bearing head of FIG. 1;

FIG. 5 is a rear view of a mounted multi-angle bearing head of FIG. 1;

FIG. 6A is a perspective front oblique view of a multi-angle bearing head with a portion of a cable passing through visible in accordance with an embodiment;

FIG. 6B is an exploded view of the multi-angle bearing head of FIG. 1

FIG. 7 is a perspective view of a multi-angle bearing head assembly of a second embodiment, wherein the multi-angle bearing head is in a raised position;

FIG. 8 is a perspective view of the multi-angle bearing head assembly of FIG. 7 is a sloped position;

FIG. 9 is a perspective view of the multi-angle bearing head assembly of FIG. 7 with the jaws of the multi-angle bearing head in an open position and in a first position relative to the base;

FIG. 10 is a perspective view of the multi-angle bearing head assembly of FIG. 7 with the jaws of the multi-angle bearing head in an open position in a second position relative to the base;

FIG. 11 is a rear perspective view of the multi-angle bearing head assembly of FIG. 7 with the jaws of the multi-angle bearing head in a closed position;

FIG. 12 is a front perspective view of the multi-angle bearing head assembly of FIG. 7 with the jaws of the multi-angle bearing head in a closed position;

FIG. 13 is an exploded perspective view of the multi-angle bearing head assembly of FIG. 7;

FIG. 14 is a schematic elevation view of an exemplary use of a hoisting apparatus comprising one of the multi-angle bearing head of FIGS. 2-6 or the multi-angle bearing head of FIGS. 7-13, wherein the hoisting apparatus is anchored on an entry-aid component mounted to a tank and before a rope being used;

FIG. 15 is a schematic elevation view of an exemplary use of a hoisting apparatus similar to the one depicted on FIG. 14 with the hoisting apparatus anchored on an entry-aid component mounted to a tank and a rope attached to a person located in the manhole;

FIG. 16 is a schematic elevation view of an exemplary use of a hoisting apparatus similar to the one depicted on FIG. 14 butted up to a tank;

FIG. 17 is a schematic elevation view of an exemplary use of a hoisting apparatus similar to the one depicted on FIG. 14 anchored to a tank;

FIG. 18 is a schematic elevation view of an exemplary use of a hoisting apparatus similar to the one depicted on FIG. 14 used to access the interior of a tank anchored to a vicinity-available structure, and

FIG. 19 is a perspective elevation view of an exemplary use of a hoisting apparatus similar to the one depicted on FIG. 14 used to access the interior of an elevator with the hoisting apparatus mounted to a frame of the elevator.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations, and does not pose a limitation on the scope of the realizations. No language in the specification should be construed as indicating any unclaimed element as essential to the practice of the realizations.

It should further be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

In the following description, it is understood that terms such as “first”, “second”, “top”, “bottom”, “above”, “below”, and the like, are words of convenience and are not to be construed as limiting terms.

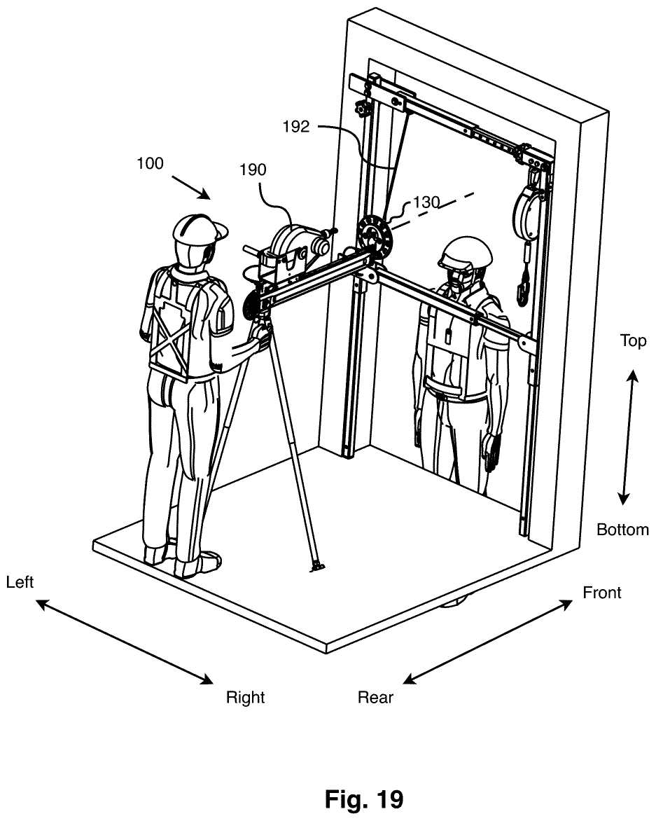

The terms “top”, “up”. “upper”, “bottom”, “lower”, “down”, “vertical”, “horizontal”, “interior” and “exterior” and the like are intended to be construed in their normal meaning in relation with normal use of a hoisting apparatus, with indication of an orientation in one orientation being provided on FIG. 19.

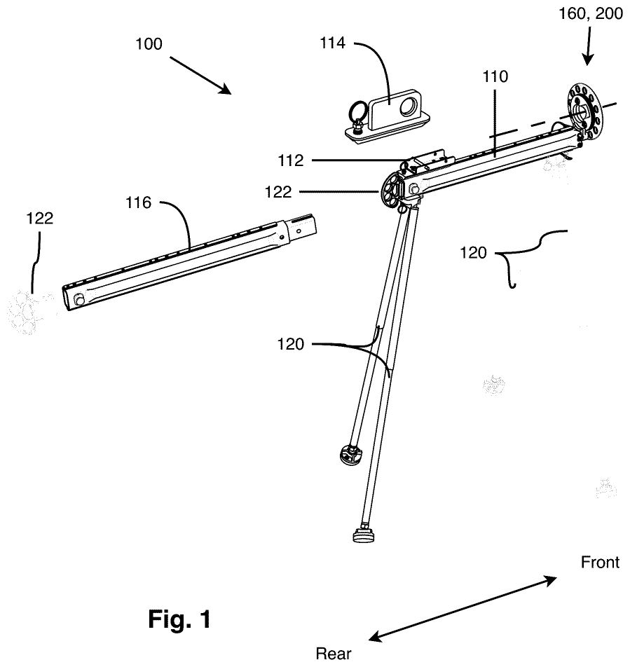

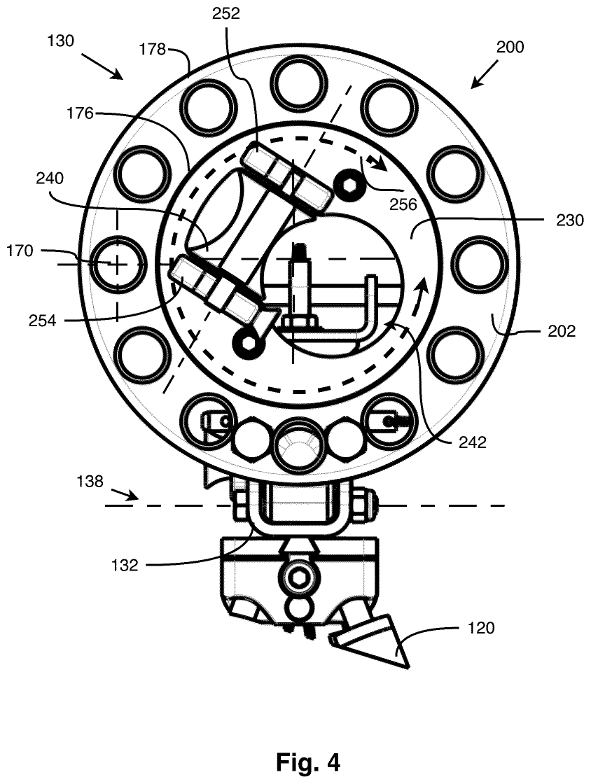

Referring now to the drawings, and more particularly to FIG. 1, the hoisting apparatus 100, that may be used as a personal protective apparatus (PPE) at a manhole which is depicted on FIGS. 1 to 6A-6B, comprises a spine 110 mounted to one or more legs 120. The hoisting apparatus 100 comprises, mounted to the front extremity, a multi-angle bearing head assembly 130 comprising e.g., a multi-angle bearing head 200, or alternatively (not depicted) a multi-angle bearing head 160, and, mounted to the rear, e.g., a hooking component 122.

According to an embodiment, the hoisting apparatus 100 comprises, mounted to the top, a fitting 112 (or anchor component 114) which can be mounted to the spine 110.

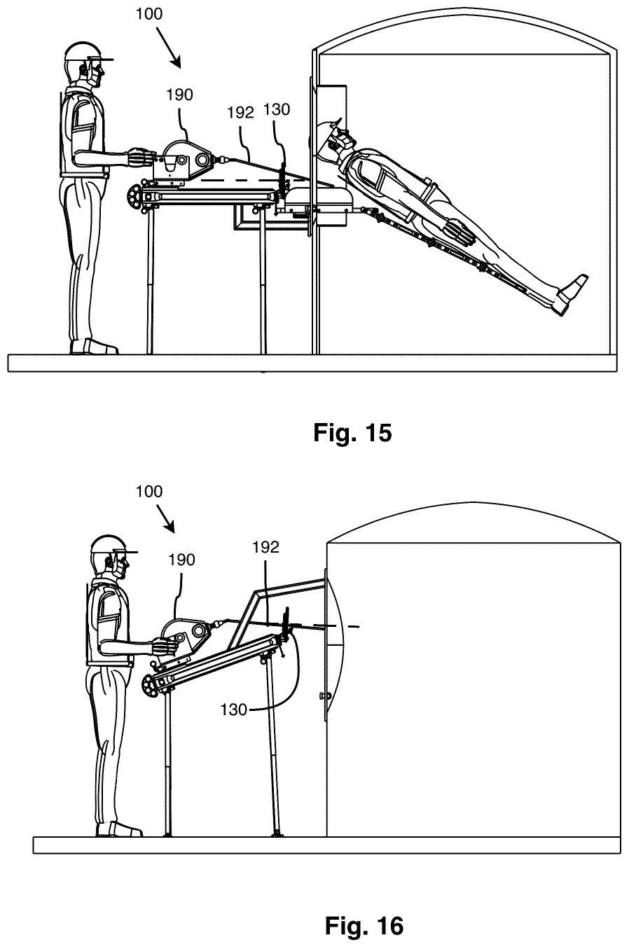

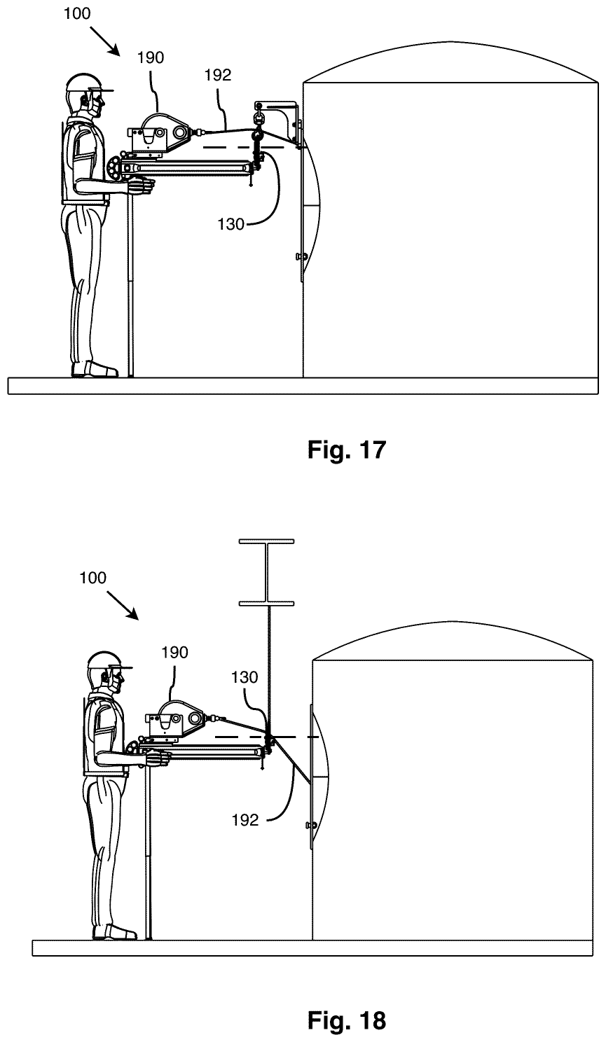

According to embodiments, the hoisting apparatus 100 may be adjustable to be mounted on e.g., two rear legs with additional support provided otherwise, see e.g., FIGS. 17 to 19, or more legs to be operated in a self-standing configuration, e.g., FIGS. 15 and 16, with or without use of additional anchoring.

It is to be noted that depiction of use of legs, and more precisely adjustable legs, is for exemplary purpose. Alternative embodiments may be mounted on leg assembly(ies) comprising a single leg assembly at the rear/front, and may e.g., be adapted to be mounted to structure(s) present in the vicinity, and thus requiring use of no leg or leg structure.

Back to FIG. 1, the hoisting apparatus 100 may be used with one or more extensions 116 to be mounted to the rear end of the spine 110, with the hooking component 122 mounted to the extension 116 or the spine 110. More components or additional legs may be mounted to the extension 116.

Further illustrated, legs 120 may be also mounted to the front of the spine 110.

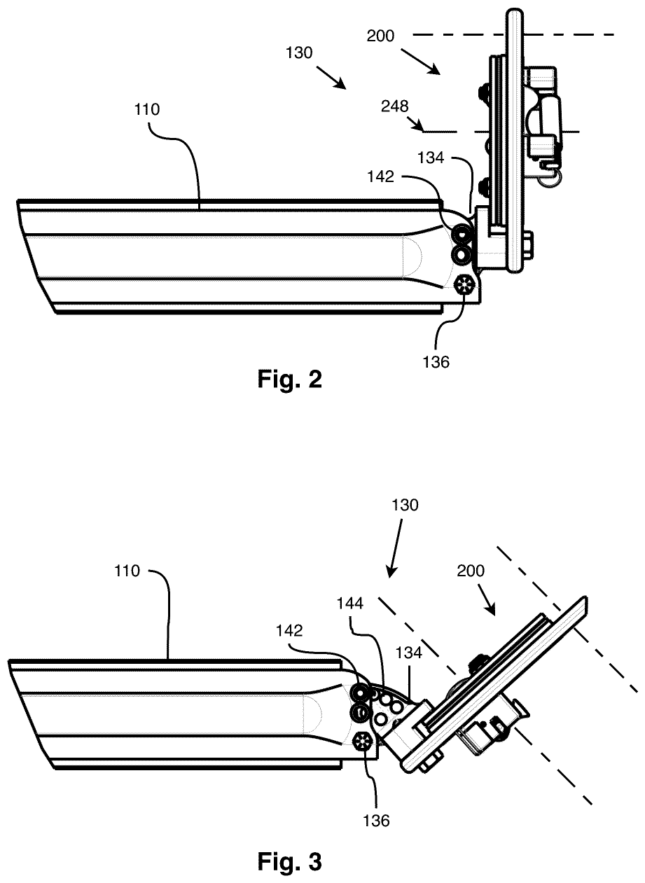

Referring now to FIGS. 2 to 5 and FIGS. 6A-6B, the multi-angle bearing head assembly 130 comprises a base 132 mountable to the front end of the spine 110. A rotatable multi-angle bearing head 200 is mounted to the base 132, providing angle adjustment of the multi-angle bearing head 200 relative to the spine 110, and more precisely rotatable between a raised position depicted on FIG. 2, and a maximal sloped position. e.g., sloped position depicted on FIG. 3.

The multi-angle bearing head 200 of this embodiment comprises a core ring 202 designed to be mounted to a rotatable support component 134. A free-pivoting disk assembly 220 is mounted to the core ring 202 to freely pivot over the core ring 202 around a passage axis 248 over more than 360 degrees.

According to an embodiment, it is contemplated that the multi-angle bearing head 200 may comprise means that may be used to lock the disk assembly 220 at a specific angle without departing from the scope contemplated through the present description, e.g., a hole close to the peripheral in the disk assembly 220 allowing to connect that hole and a hole 170 to temporarily limit rotation of the disk assembly 220.

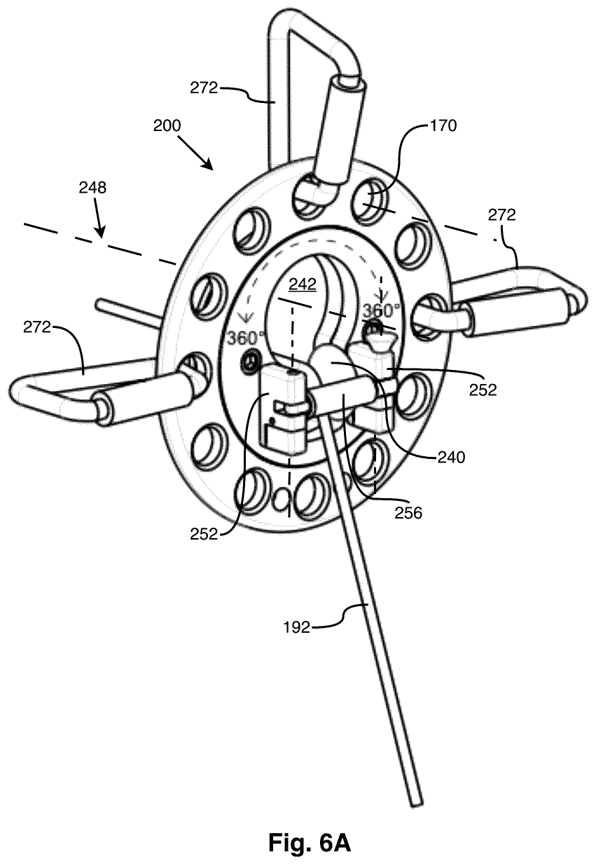

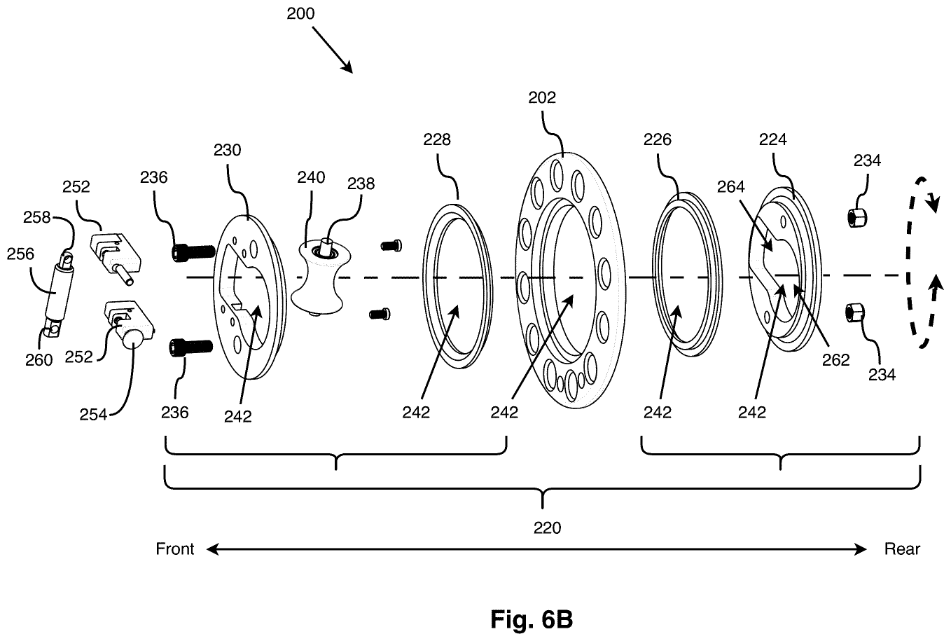

The disk assembly 220 comprises a rear disk 224, a rear coupling component 226, e.g., a Teflon™ disk or a bearing disk providing a low-friction coupling, a front coupling component 228, e.g., a Teflon™ disk or a bearing disk, and a front disk 230 that are secured together with e.g., nuts 234 and bolts 236 to wedge the core ring 202 in the center of the disk assembly 220 between the coupling components 226, 228. This solution provides capability for the disk assembly 220 to freely pivot relative to the core ring 202. The disk assembly 220 further comprises a bearing member designed to interface and support a rope, e.g., a spool 240 with its shaft 238 mounted to the front coupling component 228, for example mounted such that the shaft 238 is wedged between the front disk 230 and the front coupling component 228 thus in the disk assembly 220. The spool 240 is neighboring a central passage 242 extending across the core ring 202 and the disk assembly 220, wherein the spool 240 is adapted to provide a guide 244 to a rope or alike in the central passage 242, preventing the rope 192, FIG. 6A, e.g., to rob against the edge of the central passage 242 or other components of the multi-angle bearing head 200. Through the possibility of the disk assembly 220 to freely pivot in any direction around the passage axis 248 extending across the core ring 202, with no angular limit, the multi-angle bearing head 200 may operate with the rope 192 extending therefrom in any direction relative to the core ring 202, and may adapt to changes in tension direction with the front disk 230 pivoting to follow the changing tension direction seamlessly, forcing the whole disk assembly 220 to pivot accordingly.

According to an embodiment, the multi-angle bearing head 200 further comprises a pair of fittings 252 mounted to the front disk 230, with a guiding shaft 256, aka a pilot 256, mounted thereto, wherein the pilot 256 provides an additional guide, aka path, to a rope 192. The pilot 256 has a first end 258 and a second end 260 with the first end 258 being rotatable relative to a first one of the fittings 252. A releasable pin 254 is releasably mountable to the second fitting 252 and adapted to releasably mount the second end 260 of the pilot 256 to the second fitting 252 to easily insert the rope therebetween and to keep the pilot 256 in place afterwards.

According to an embodiment, the central passage 242 in the disk assembly 220 has a combination of a first circular portion 262 eccentric to the disk assembly 220 and a rectangular portion 264 providing a keyhole-shape-like clearance for the spool 240 to extend partially through the core ring 202, with the central passage 242 extending with at least that opening size through the rear disk 224, the rear coupling component 226, the front coupling component 228 and the front disk 230.

According to a preferred embodiment, the spool 240 has a generally concave shape with the diameter of the spool 240 varying along its axis, decreasing from greater diameter(s) about its edges to a narrow diameter in-between.

The multi-angle bearing head 200 further comprises a series of holes 170 extending over its periphery between the inner edge 176 and the outer edge 178 of the ring 202, wherein the holes 170 available for hooking or tying the multi-angle bearing head 200 for e.g., for e.g., stabilizing the multi-angle bearing head 200 or additional ropes, gears, or other components to be either attached thereto and to travel with the rope 192, or secured thereto for other purposes. Carabiners 272 depicted in FIG. 6A illustrates that particular usage.

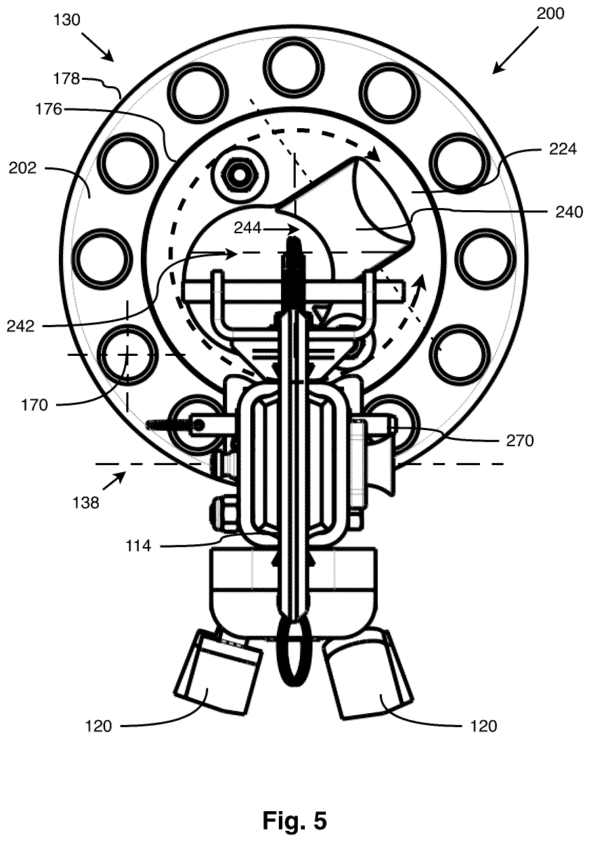

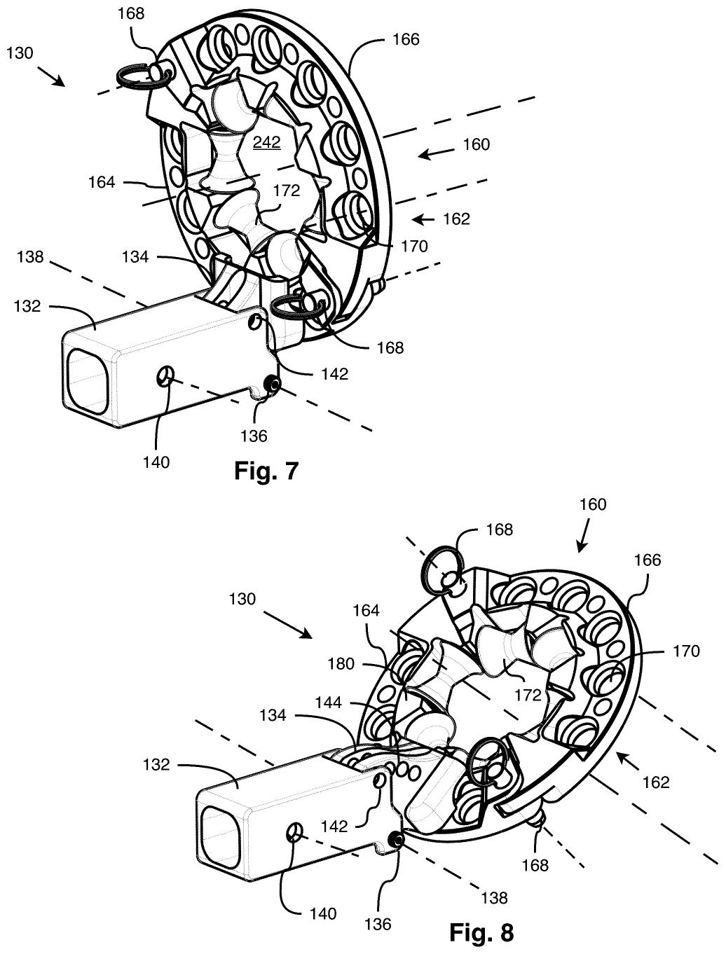

Referring now to FIGS. 7 and 8, according to another embodiment, an alternative multi-angle bearing head assembly 130 comprises a base 132, a rotatable support component 134 mounted to the base 132 through a pin, screws, or a bolt 136 defining the rotation axis 138 of the rotatable support component 134 relative thereto. A first hole 140 on the base 132 is for securing the base 132, once inserted, to the spine 110 (e.g., FIG. 1). A second hole 142, when holes 142 and holes 144 are aligned, permits, through the insertion of a pin 270 (e.g., FIG. 5) to controllably secure the slope of the rotatable support component 134 relative to the base 132.

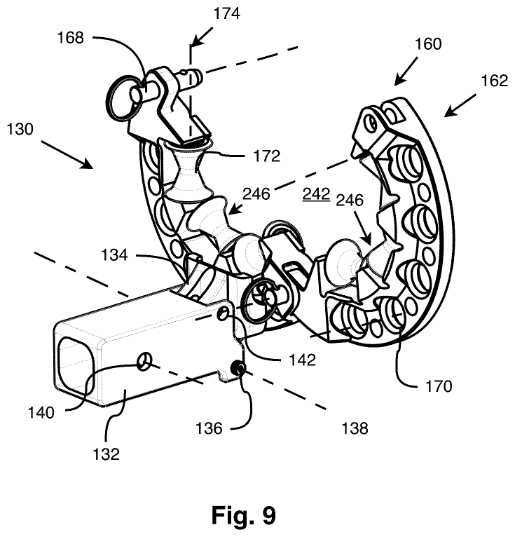

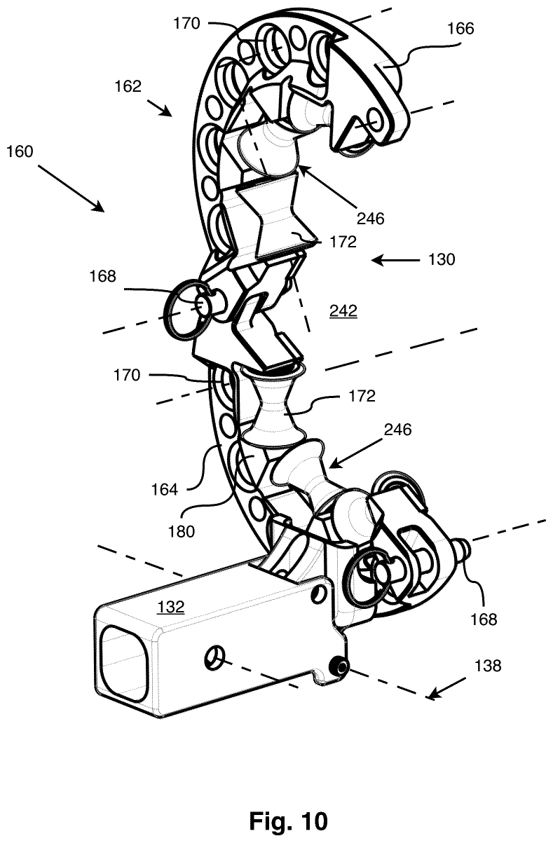

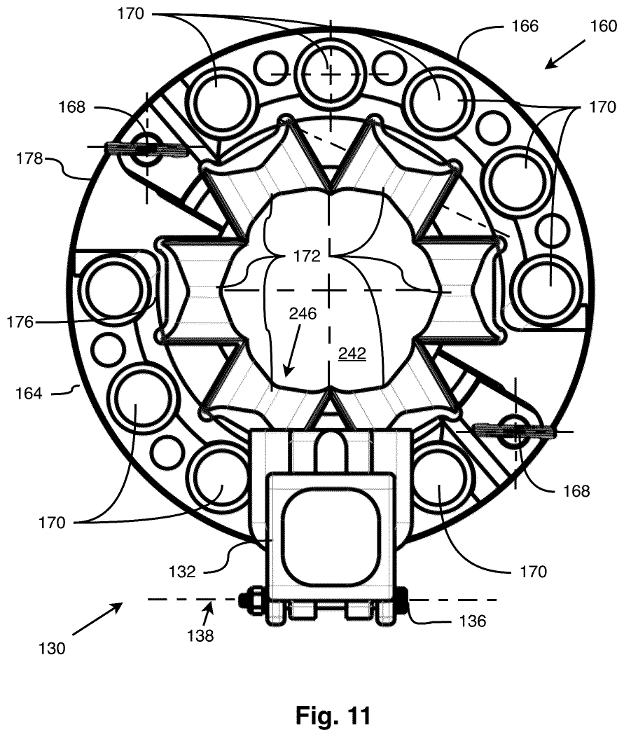

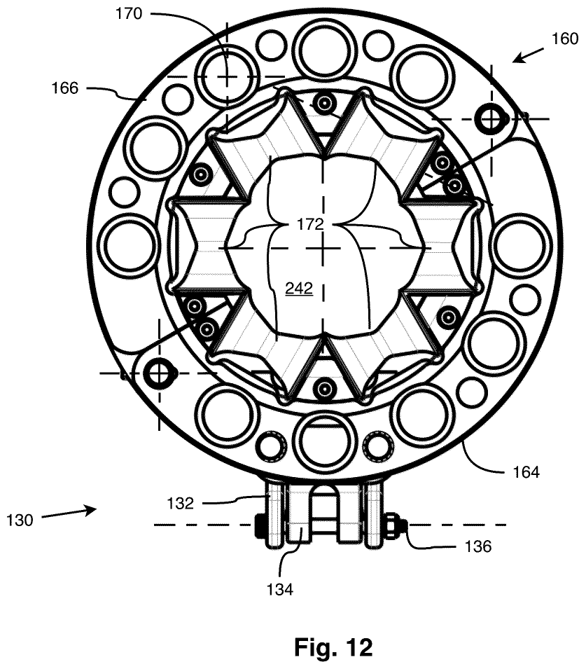

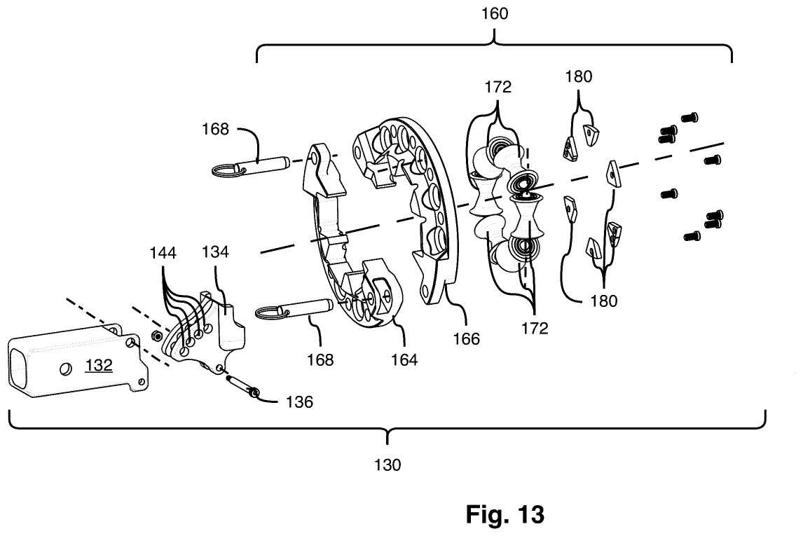

Referring additionally to FIGS. 9 to 13, the multi-angle bearing head 160 comprises a ring assembly 162 mounted to the rotatable support component 134 comprising a first half ring 164, aka a first jaw, mounted to the rotatable support component 134, and a second half ring 166, aka second jaw, rotatably mounted to the first half ring 164, and securable with at least one pin 168 in a closed position in which the half rings 164, 166 have the ring assembly 162 in a closed position. When in the closed position, the ring assembly 162 provides therein a guiding surface 246 having a closed perimeter.

The multi-angle bearing head 160 further comprises, distributed over the ring assembly 162, a series of holes 170 extending through the ring assembly 162, e.g., parallel to the base 132 when the multi-angle bearing head assembly 130 is raised, wherein the holes 170 are of the same purpose(s) as the holes 170 of the multi-angle bearing head 160, thus which e.g., may be used e.g., to hook or tie a rope, or pass a rope therethrough for tie-off.

On the rear side, mounted to the half rings 164, 166 are guiding components 172 mounted with e.g., their pivot axis 174 (with the pivot axis 174 of a single guiding component 172 depicted on FIG. 9), generally perpendicular to the center of the multi-angle bearing head 160.

According to a preferred embodiment, the guiding components 172 consists in spools 172, preferably neighboring spools 172 having a pivot axis 174 oblique to the pivot axes of the neighbor ones within a common plane, providing together a guiding surface 246 with gaps smaller than the diameter of a rope (e.g., rope 192, FIG. 6A) intended to be used therewith. The spools 172 have a generally concave shape with the diameter of the spools 172 varying along its pivot axis 174, aka, decreasing from greater diameters about the edges to one or more narrow diameters in-between. According to an embodiment, the profile of the spools 172 is one of a U shape, a V shape, and preferably a shape having from the edge first slope relative to the pivot axis 174 of the spool 172, a second slope of smaller value relative to the pivot axis 174 of the spool 172, and a central rounded or flat portion of minimal diameter. According to a preferred embodiment, the spools 172 are maintained in place with triangular fittings 180 screwed on the ring assembly 162, wherein the triangular fittings 180 are maintaining the shafts (not identified) of the spools 172 in grooves (not identified) present in the ring assembly 162.

It is worth mentioning that the ring assembly 162 has an outside edge 178 and a generally inside edge 176, with the spools 172 being mounted at least partially inward relative to the inside edge 176 of the ring assembly 162, thereby adapted to guide a rope distant from the inside edge 176 and therethrough preventing premature wear of the rope.

According to a preferred embodiment, the number of spools 172 is at least six (6) closely neighboring each other, with the profiles of the spools 172 defining a perimeter to the central passage 242 of the ring assembly 162 providing substantially no path for a rope to escape the guiding surface 246 provided by the spools 172 to reach the edge of the ring assembly 162. Accordingly, the edges of neighboring spools 172 are designed to be close to one another, with the distance between them being smaller than the diameter of a rope to be used with the multi-angle bearing head assembly 130, and preferably substantially smaller, e.g., less than 50%, and preferably less than 30% of the diameter of the rope to be used with the multi-angle bearing head 160.

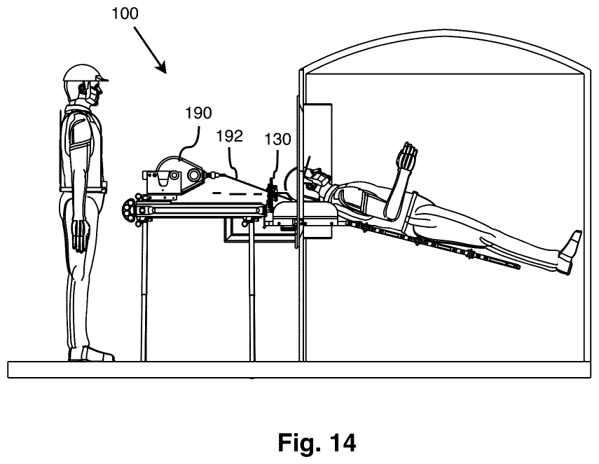

Referring now particularly to FIGS. 14 to 19, the hoisting apparatus 100 is adapted to face a variety of situations. For instance, the hoisting apparatus 100 may be used e.g., with the front and the rear of the spine 110 supported by legs 120, for instance additionally abutted or anchored to the structure, e.g., tank, comprising a manhole, see FIGS. 14 and 15 wherein the hoisting apparatus 100 is abutted below the manhole, before and after tying a rope to secure someone utilizing the manhole, and FIG. 16 wherein the hoisting apparatus 100 is abutted to the tank above the manhole, or e.g., with the rear of the hoisting apparatus 100 supported by legs 120 and the hoisting apparatus 100 anchored frontward to the location of the legs 120 to the tank, see FIG. 17 or a structure present in the vicinity of the tank, see FIG. 18.

In some embodiment, e.g., FIG. 19, a provisional additional frame to the structure, such as a removable frame to the door of an elevator as depicted on FIG. 19, may be used to anchor and/or e.g., partially support the hoisting apparatus 100.

In embodiments, a reel assembly 190 may be mounted to the rear of the spine 110, with the rope 192 exiting the reel assembly 190, extending through the multi-angle bearing head 160, 200, and the extremity of the rope 192 being tied up to a person or an accessories to.

In some cases, the rope may extend from the reel assembly 190 to the person with or without the multi-angle bearing head 160, 200 guiding the rope 192 in-between, e.g., FIGS. 15, 16 and 18, or even with additional rope guiding components mounted upstream or downstream to the multi-angle bearing head 160, 200.

It is contemplated that the combinations of multi-angle bearing heads and bases descried therein are interchangeable in new combinations, as features described specifically in relation with one being transferable to the other.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A multi-angle bearing head, comprising:
a ring defining a central passage therethrough; and
at least one bearing member coupled to the ring, the at least one bearing member extending at least partially within the central passage thereby providing a guide for a rope to pass through the ring by the central passage without the rope robbing against the ring.

2. The multi-angle bearing head of claim 1, wherein the ring comprises an inner edge and an outer edge, and a hole distant from the inner edge and the outer edge.

3. The multi-angle bearing head of claim 1, comprising a support secured to the ring.

4. The multi-angle bearing head of claim 3, wherein the support comprises a support component secured to the ring, a base securable to a structure, wherein the support component and the base are rotatable relative to each other.

5. The multi-angle bearing head of claim 4, wherein the support component and the base comprise holes that can be aligned when the support component is rotated at a first angle and at a second angle relative to the base, and a pin mountable to the holes to releasably secure the multi-angle bearing head at the first angle and at the second angle.

6. The multi-angle bearing head of claim 1, wherein comprising a disk assembly coupled to the ring, the disk assembly adapted for freely pivoting around a passage axis extending through the central passage.

7. The multi-angle bearing head of claim 6, wherein the bearing member is a spool mounted to the disk assembly.

8. The multi-angle bearing head of claim 6, wherein the disk assembly comprises a first disk and a second disk that are coupled to each other with the ring wedged in-between.

9. The multi-angle bearing head of claim 8, wherein the disk assembly comprises a low-friction coupling component wedged between the first disk and the ring.

10. The multi-angle bearing head of claim 9, wherein the ring comprises a circular inner edge, and wherein the coupling component is adapted for the first disk to slide relative to the inner edge and thereby pivoting around the passage axis.

11. The multi-angle bearing head of claim 8, wherein the bearing member is a spool comprising a shaft wedged between the first disk and the second disk.

12. The multi-angle bearing head of claim 8, further comprising fittings mounted to the first disk, and a pilot mounted to the fittings providing a path for the rope between the pilot and the bearing member.

13. The multi-angle bearing head of claim 12, wherein the pilot has a first end and a second end, the guide being rotatable relative to a first one of the fittings, the multi-angle bearing head comprising a releasable pin adapted to releasably mount the second end to a second one of the fittings.

14. The multi-angle bearing head of claim 6, wherein the disk assembly is able to freely pivot around the passage axis, being thereby able to pivot over more than 360 degrees.

15. The multi-angle bearing head of claim 7, wherein the spool has two edges having an edge diameter, and an intermediary diameter in-between that is smaller than the edge diameter.

16. The multi-angle bearing head of claim 1, wherein the ring consists in a first jaw and a second jaw rotatable relative to the first jaw between an open position and a closed position.

17. The multi-angle bearing head of claim 16, wherein the bearing member consists of a plurality of spools neighboring each other and providing together a guiding surface with gaps smaller than a diameter of the rope to be used.

18. The multi-angle bearing head of claim 17, wherein the neighboring spools have pivot axes that are oblique to each other.

19. The multi-angle bearing head of claim 17, wherein the guiding surface defines a closed perimeter in the closed position.

20. An apparatus used as a hoisting apparatus or a personal protective apparatus for use at a manhole, the apparatus comprising:
a structure; and
a multi-angle bearing head according to claim 1, the multi-angle bearing head being coupled to the structure,
wherein the multi-angle bearing head defines a passage having a substantially closed perimeter adapted for a rope to pass therethrough.
